(19) United States
(12) Patent Application Publication
(10) Pub. No.: US 2005/0188190 A1
(43) Pub. Date: Aug. 25, 2005

(54) Facilitating customization of embedded system functionality

(75) Inventors: Jonathan Cassorla, Austin, TX (US); Jeremy Mark Ellington, Austin, TX (US); Joseph A. Bulger JR., Austin, TX (US)

Correspondence Address: Raymond M. Galasso;Simon, Galasso & Frantz PLC, P.O. Box 26503, Austin, TX, 78755-0503, US

(73) Assignee: NEWISYS, INC.

(21) Appl. No.: 10/787,066

(22) Filed: Feb. 24, 2004

(51) Int. Cl. G06F 9/00

(52) U.S. Cl. 713/1

(57) ABSTRACT

A computer system comprises a service processor, flash memory, and service processor main memory accessible by the service processor and coupled to the flash memory. The service processor is coupled to various data processing system components of the computer system. The flash memory includes protected memory space having protected system functionality components stored therein and unprotected memory space having a custom system functionality component stored therein. The protected system functionality components and the custom system functionality component are loadable into the service processor main memory from the flash memory. The custom system functionality component is stored in place of a corresponding default system functionality component that is designated as being customisable. The protected system functionality components, which are not customisable, and the custom system functionality component jointly define system functionality and enable customisation of such system functionality in a template-like manner. Enabling customisation in a template-like manner refers to the custom system functionality components being overlayed onto the protected system functionality components in a predetermined manner and in a manner that precludes modification to an underlying structure of associated source code.

### FIELD OF THE DISCLOSURE

The disclosures made herein relate generally to data processing systems and, more particularly, to facilitating customisation of system functionality.

### BACKGROUND

Original Equipment Manufacturers (OEMs) of computing systems (e.g., servers) often distribute such systems through indirect channels. In doing so, their products are sold by resellers or downstream equipment manufacturers (i.e., distributing entities) that often have the desire to customize the look and feel of various aspects of such systems (e.g. the user interfaces). Examples of reasons for undertaking such customisation are to better align the system with their own product line standards and/or to replace system management software components to achieve customized system functionality.

Conventional approaches through which such customisation was solved include the OEM providing source code to distributing entities. For example, the source code is often provided under a product licensing agreement to a distributing entity. Accordingly, such a distributing entity not only licenses the hardware platform, but the source code as well. With such a license, the distributing entity is able to modify and customize the source code (i.e., customized source code) to fit their needs. The customized source code is then distributed on the computing systems that they sell.

There are several limitations associated with the sharing of source code. One limitation is that it is not extremely efficient from a logistical standpoint. Another limitation is that that some distributing parties will require expensive professional services for facilitating customisation of the source code. Still another limitation is that, from an intellectual property standpoint, it is often not desirable to share the source code with distributing entities. Yet another limitation is that the party customizing the source code must have the capability to re-build the source code once customized.

Therefore, facilitating customisation of system functionality in a manner that overcomes limitations associated with conventional approaches for customizing system functionality would be useful and novel.

### BRIEF DESCRIPTION OF THE DRAWINGS

FIG. 1 depicts a computer system configured for providing customized system functionality in accordance with an embodiment of the disclosures made herein.

FIG. 2 depicts a method for facilitating customisation of an embedded system in accordance with an embodiment of the disclosures made herein.

### DETAILED DESCRIPTION OF THE DRAWINGS

Memory arrangements and methods in accordance with the disclosures made herein (i.e., the inventive disclosures) are configured for facilitating customisation of embedded system functionality in a streamlined manner. Specifically, one or more default system functionality components, which are designated as being customisable (i.e., customisable system functionality components) by an original equipment manufacturer of the computer system, are replaced with one or more corresponding custom system functionality components. Protected system functionality components, which are not customisable, and customisable system functionality components jointly define system functionality and enable customisation of such system functionality in a template-like manner. Enabling customisation in a template-like manner refers to the custom system functionality components being overlayed onto the protected system functionality components in a predetermined manner and in a manner that precludes modification to an underlying structure of associated source code. An embedded processor (e.g., a service processor) interprets the system functionality components for imparting system functionality. Examples of such default system functionality components include, but are not limited to, displayed images, system component data repositories, various user interface information, product identification maps, system management software components (e.g., various executable commands and monitor/control process event information) and the like.

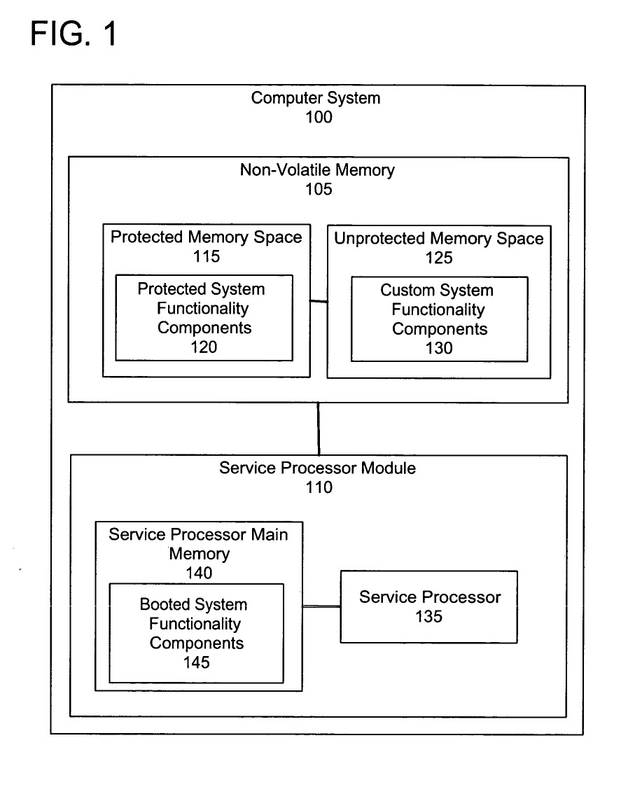

Memory arrangements and methods in accordance with embodiments of the disclosures made herein provide a simple and effective means for enabling distributing entities (e.g., resellers and equipment manufacturers downstream of the OEM) and/or original equipment manufacturers of computer system (e.g., servers) to customize system functionality in such computer systems. For example, such memory arrangements and methods provide a distributing entity with the means for altering a default look and feel to more directly reflect a preferred look and feel. An advantage of such memory arrangements and methods is that they facilitate a “streamlined” process by which a distributing entity can provide their customisation of the system functionality without requiring access to the original equipment manufacturer's source code (with the possible exception of some interface specifications and binary libraries) and without having to secure professional services. Because changes to the source code are not required, there is no need for the distributing entity to re-build and re-distribute an entire software load. The distributing entity simply creates one or more custom system functionality components and loads these components into memory (i.e. 130 of FIG. 1).

Turning now to specific figures, FIG. 1 depicts a computer system 100 (e.g., a server) configured for providing customized system functionality in accordance with an embodiment of the disclosures made herein. The computer system 100 includes non-volatile memory 105 (e.g., non-volatile flash memory) coupled to a service processor module 110. The non-volatile memory 105 and the service processor module 110 are comprised by an embedded system of the computer system 100. The non-volatile memory 105 includes protected memory space 115 having protected system functionality components 120 stored therein and unprotected memory space 125 having a custom system functionality component 130 stored therein.

The service processor module 110 includes a service processor 135 (i.e., a processor of an embedded system) coupled to service processor main memory 140 (i.e., processor random access memory) and to other system components (not specifically shown) of the computer system 100. Examples of such other system components include components that provide server operating system functionality on a platform side of the server (i.e., a platform-side operating system). The service processor module 110 provides functionality such as remote management, diagnostics, discovery and/or monitoring support of the platform-side operating system.

The service processor main memory 140 is accessible by the service processor 135 and is coupled to the non-volatile memory 105. Accordingly, the service processor main memory 140 is accessible by the service processor 135, and the contents stored in the non-volatile memory (e.g., the protected system functionality components 120 and the custom system functionality components 130) are loadable into the service processor main memory 140 from the non-volatile memory 105. Once loaded, the protected system functionality components 120 and the custom system functionality components 130 are comprised by booted system functionality components upon which operation of the service processor 135 is dependent.

The protected system functionality components 120 are exclusively configurable by a designated entity (e.g., an original equipment manufacturer of the computer system). The custom system functionality components 130 are configurable (e.g., created) by an entity other than the designated entity (e.g., a reseller or downstream equipment manufacturer). The term protected memory space refers to memory space allocated for holding the protected system functionality components. The term unprotected memory space refers to memory space allocated for holding the customisable system functionality components (i.e., customized system functionality components or default system functionality components that are customisable.) In one embodiment, the protected system functionality components 120 and the custom system functionality components 130 are comprised by system management software (not specifically shown). In one embodiment, the service processor 135 includes a component creation utility (e.g., a command line utility) that is configured for facilitating creation of the custom system functionality components and loading of the custom system functionality components in the unprotected memory space 125 of the non-volatile memory 105.

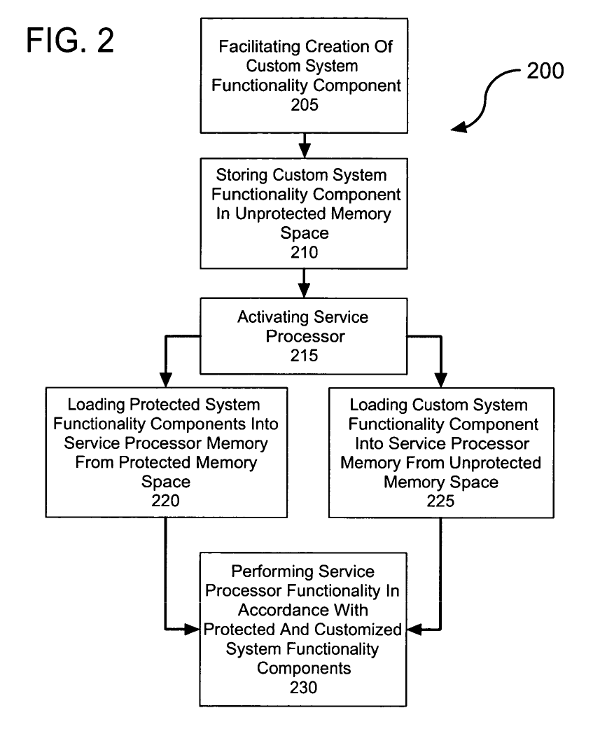

FIG. 2 depicts a method for facilitating customization of an embedded system in accordance with an embodiment of the disclosures made herein. It should be understood and is contemplated herein that the computer system 100 depicted in FIG. 1 is one embodiment of a system capable of facilitating the method 200. Accordingly, it should be understood and is contemplated herein that implementation of methods in accordance with embodiments of the disclosures made herein (e.g., the method 200 depicted in FIG. 2) are not limited to being facilitated by the computer system 100.

An operation 205 is performed for facilitating creation of a custom system functionality component. Facilitating creation of the custom system functionality components includes identifying a collection of default system functionality components. Each one of the default system functionality components (i.e., customisable system functionality components) is replaceable with a corresponding customized system functionality component. For example, a component creation utility of the service processor 135 displays a collection of customisable system functionality components.

After creating the custom system functionality component, an operation 210 is performed for storing the custom system functionality component in unprotected memory space (e.g., of non-volatile flash memory). In one embodiment, storing the custom system functionality component includes overwriting a default system functionality component (e.g., an OEM provided default system functionality component) with the custom system functionality component. The component creation utility of the service processor 135 is an example of a means for facilitating storing the custom system functionality component in the unprotected memory space (e.g., burning the custom system functionality component into non-volatile flash memory).

After the custom system functionality component is stored in the unprotected memory space and in response to performing an operation 215 for activating the processor (e.g., booting, rebooting or applying/re-applying power to the processor), an operation 220 is performed for loading protected system functionality components into memory accessible by the processor (e.g., main memory of a service processor where an operating system is booted and system management software is started) from protected memory space of the non-volatile memory and an operation 225 is performed for loading the custom system functionality component into the memory accessible by the processor from unprotected memory space of the non-volatile memory. In one embodiment, the custom and protected system functionality components are stored in the non-volatile memory in a compressed format and loading such system functionality components includes uncompressing such system functionality components into the memory accessible by the processor (e.g. FIG. 1, processor 135).

After loading the protected system functionality components and the custom system functionality component, an operation 230 is performed for facilitating service processor functionality in accordance with at least a portion of the protected system functionality components and the custom system functionality component. Accordingly, through the method 200 depicted in FIG. 2, an effective yet simple approach for customizing system functionality is provided. Although the method 200 depicted in FIG. 2 refers to a single custom system functionality component, it is contemplated and disclosed herein that methods in accordance with embodiments of the disclosures made herein may be carried out simultaneously and/or sequentially for a plurality of custom system functionality components.

Referring now to computer readable medium in accordance with embodiments of the disclosures made herein, methods, processes and/or operations as disclosed herein for enabling disclosed customisation of an embedded system are tangibly embodied by computer readable medium having instructions thereon for carrying out such methods, processes and/or operations. In one specific example, instructions are provided for carrying out the various operations of the methods, processed and/or operations depicted in FIG. 2 and/or associated with the computer system depicted in FIG. 1. The instructions may be accessible by one or more processors (i.e., data processing devices providing service processor functionality) of a computer system as disclosed herein (i.e., a server) from a memory apparatus of the computer system (e.g. RAM, ROM, flash memory, virtual memory, hard drive memory, etc). Examples of computer readable medium include a compact disk or a hard drive, which has imaged thereon a computer program adapted for carrying out disclosed embedded system customisation functionality.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical, chemical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A computer system, comprising:
a processor coupled to data processing system components;
first memory including protected memory space having protected system functionality components stored therein and unprotected memory space having a custom system functionality component stored therein; and
second memory accessible by the processor and coupled to said first memory;
wherein said protected system functionality components and said custom system functionality component are loadable into said second memory from said first memory.

2. The computer system of claim 1 wherein said protected system functionality components and said custom system functionality components are comprised by system management software.

3. The computer system of claim 2 wherein said custom system functionality component is stored in place of a corresponding default system functionality component of said system management software.

4. The computer system of claim 1 wherein said first memory is non-volatile memory.

5. The computer system of claim 4 wherein said non-volatile memory is flash memory.

6. The computer system of claim 5 wherein:
the processor is a service processor; and
said second memory is service processor main memory.

7. The computer system of claim 1 wherein:
said protected system functionality components are exclusively configurable by a original equipment manufacturer of the system; and
said custom system functionality component is configurable by any entity, including the original equipment manufacturer of the system.

8. The computer system of claim 7 wherein:
said protected system functionality components and said custom system functionality component are comprised by system management software;
said first memory is flash memory; and
said second memory is service processor main memory.

9. The computer system of claim 1, further comprising:
a component creation utility configured for facilitating creation and loading of said custom system functionality component.

10. A method for facilitating customization of an embedded system, comprising:
storing a custom system functionality component in unprotected memory space of first memory;
loading protected system functionality components and said custom system functionality component into second memory from said first memory in response to activating a service processor coupled to said second memory; and
performing service processor functionality in accordance with at least a portion of said protected system functionality components and said custom system functionality component.

11. The method of claim 10 wherein storing said custom system functionality component includes overwriting a default system functionality component with said custom system functionality component.

12. The method of claim 10 wherein:
said protected system functionality components are stored in a compressed format in protected memory space of said first memory;
said custom system functionality component is stored in a compressed format in said unprotected memory space of said first memory; and
loading said protected system functionality components and said custom system functionality component into said second memory includes uncompressing said protected system functionality components and said custom system functionality component.

13. The method of claim 10, further comprising:
facilitating creation of said custom system functionality component.

14. The method of claim 13 wherein:
facilitating creation of said custom system functionality components includes identifying a collection of default system functionality components; and
each one of said default system functionality components is replaceable with a corresponding customized system functionality component.

15. The method of claim 14 wherein storing said custom system functionality component includes overwriting a corresponding one of said default system functionality components with said custom system functionality component.

16. A computer system, comprising:
at least one data processing device;
instructions processable by said at least one data processing device; and
an apparatus from which said instructions are accessible by said at least one data processing device;
wherein said instructions are configured for enabling said at least one data processing device to facilitate:
storing a custom system functionality component in unprotected memory space of first memory;
loading protected system functionality components and said custom system functionality component into second memory from said first memory in response to activating a service processor coupled to said second memory; and
performing service processor functionality in accordance with at least a portion of said protected system functionality components and said custom system functionality component.

17. The computer system of claim 16 wherein storing said custom system functionality component includes overwriting a default system functionality component with said custom system functionality component.

18. The computer system of claim 16 wherein:
said protected system functionality components are stored in a compressed format in protected memory space of said first memory;
said custom system functionality component is stored in a compressed format in said unprotected memory space of said first memory; and
loading said protected system functionality components and said custom system functionality component into said second memory includes uncompressing said protected system functionality components and said custom system functionality component.

19. The computer system of claim 16, further comprising:
facilitating creation of said custom system functionality component.

20. The computer system of claim 19 wherein:
facilitating creation of said custom system functionality components includes identifying a collection of default system functionality components; and
each one of said default system functionality components is replaceable with a corresponding customized system functionality component.

21. The computer system of claim 20 wherein storing said custom system functionality component includes overwriting a corresponding one of said default system functionality components with said custom system functionality component.
